(19) United States
(12) Patent Application Publication
(10) Pub. No.: US 2025/0308352 A1
(43) Pub. Date: Oct. 2, 2025

(54) DATA PROCESSING METHOD, APPARATUS, AND ELECTRONIC DEVICE

(71) Applicant: Lenovo (Beijing) Limited, Beijing (CN)

(72) Inventors: Shu GAO, Beijing (CN); Liang ZHANG, Beijing (CN)

(21) Appl. No.: 19/091,290

(22) Filed: Mar. 26, 2025

(30) Foreign Application Priority Data
Mar. 28, 2024 (CN) 202410367925.3

(51) Int. Cl. G08B 6/00; H04L 65/1089

(52) U.S. Cl. CPC G08B 6/00; H04L 65/1089

(57) ABSTRACT

A data processing method includes, in response to a target instruction, continuously obtaining a plurality of frames of captured images and in response to the target instruction, obtaining a configuration parameter for at least one control instruction. The plurality of frames of captured images forms first data. The configuration parameter forms second data, and the at least one control instruction is used to call at least one vibration apparatus. The method further includes, based on the first data and the second data, generating target data. The target data is used to output a vibration in response to the configuration parameter of the control instruction during a process of outputting the plurality of frames of captured images.

### CROSS-REFERENCE TO RELATED APPLICATION

The present application claims priority to Chinese Patent Application No. 202410367925.3, filed on Mar. 28, 2024, the entire content of which is incorporated herein by reference.

### TECHNICAL FIELD

The present disclosure is related to the computer technology field and, more particularly, to a data processing method, apparatus, and electronic device.

### BACKGROUND

An electronic device usually has a recording function. However, the existing recording function needs to be enhanced.

### SUMMARY

An aspect of the present disclosure provides a data processing method. The method includes, in response to a target instruction, continuously obtaining a plurality of frames of captured images and in response to the target instruction, obtaining a configuration parameter for at least one control instruction. The plurality of frames of captured images forms first data. The configuration parameter forms second data, and the at least one control instruction is used to call at least one vibration apparatus. The method further includes, based on the first data and the second data, generating target data. The target data is used to output a vibration in response to the configuration parameter of the control instruction during a process of outputting the plurality of frames of captured images.

An aspect of the present disclosure provides a data processing apparatus, including a first acquisition module, a second acquisition module, and a generation module. The first acquisition module is configured to continuously obtain a plurality of frames of captured images in response to a target instruction. The plurality of frames of captured images forms first data. The second acquisition module is configured to obtain a configuration parameter for at least one control instruction in response to the target instruction. The configuration parameter forms second data. The control instruction is used to call at least one vibration apparatus. The generation module is configured to generate target data based on the first data and the second data. The target data is used to output a vibration in response to the configuration parameter of the control instruction during a process of outputting the plurality of frames of captured images.

An aspect of the present disclosure provides an electronic device, including a collection assembly and a processor. The collection assembly is configured to collect images. The processor is configured to, in response to a target instruction, continuously obtain a plurality of frames of captured images, and in response to the target instruction, obtain a configuration parameter for at least one control instruction. The plurality of frames of captured images forms first data. The configuration parameter forms second data. The at least one control instruction is used to call at least one vibration apparatus. The processor is further configured to, based on the first data and the second data, generate target data. The target data is used to output a vibration in response to the configuration parameter of the control instruction during a process of outputting the plurality of frames of captured images.

### BRIEF DESCRIPTION OF THE DRAWINGS

FIG. 1 is a schematic flowchart of a data processing method according to some embodiments of the present disclosure.

FIG. 2 is a schematic flowchart of another data processing method according to some embodiments of the present disclosure.

FIG. 3 is a schematic flowchart of another data processing method according to some embodiments of the present disclosure.

FIG. 4 is a schematic flowchart of another data processing method according to some embodiments of the present disclosure.

FIG. 5 is a schematic flowchart of another data processing method according to some embodiments of the present disclosure.

FIG. 6 is a schematic structural diagram of a data processing apparatus according to some embodiments of the present disclosure.

### DETAILED DESCRIPTION OF THE EMBODIMENTS

The technical solution of embodiments of the present disclosure is described in detail in connection with the accompanying drawings of embodiments of the present disclosure. Obviously, the described embodiments are only some embodiments of the present disclosure, and not all embodiments. Based on embodiments of the present disclosure, all other embodiments obtained by those of ordinary skill in the art without creative efforts fall within the scope of the present disclosure.

To make the above objectives, features, and advantages of the present disclosure more obvious and understandable, the present disclosure is further described in detail in conjunction with the accompanying drawings and specific embodiments.

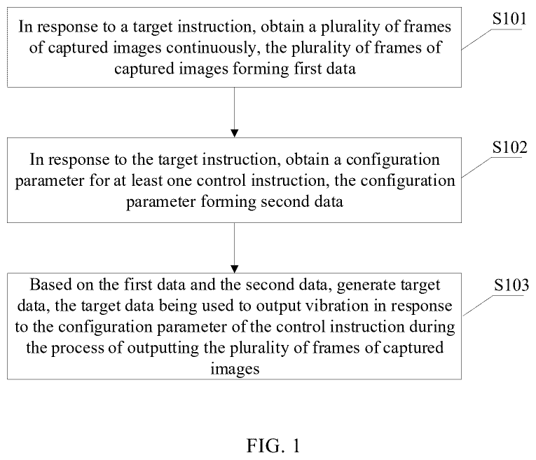

FIG. 1 is a schematic flowchart of a data processing method according to some embodiments of the present disclosure. The method can be applied to an electronic device. The type of the electronic device is not limited in the resent disclosure. As shown in FIG. 1, the method includes but is not limited to the following processes.

At S101, in response to a target instruction, a plurality of frames of captured images are obtained continuously, and the plurality of frames of captured images form first data.

In embodiments of the present disclosure, in response to the target instruction, the plurality of frames of captured images can be continuously obtained based on an acquisition method corresponding to the target instruction. The acquisition method corresponding to the target instruction is not limited.

The plurality of frames of captured images forming the first data can include but is not limited to, the plurality of frames of captured images forming an animated image (i.e., a dynamic photo).

The plurality of frames of captured images forming the first data can include but is not limited to, the plurality of frames of captured images forming a video.

At S102, in response to the target instruction, a configuration parameter for at least one control instruction is obtained, and the configuration parameter forms second data.

In embodiments of the present disclosure, the electronic device includes a vibration function. The vibration function can be realized through a vibration apparatus (e.g., a vibration motor) in the electronic device. The vibration apparatus can vibrate by being called.

In response to the target instruction, the plurality of frames of captured images can be continuously obtained, and one or more control instructions can also be generated. The control instructions can be used to call at least one vibration apparatus.

In response to the target instruction, for each control instruction, the configuration parameters for the control instruction can be obtained.

The configuration parameter for the control instruction can include but is not limited to at least one of vibration intensity, vibration frequency, or vibration duration.

A control instruction can be used to call the vibration apparatus once. When the vibration apparatus is called once, the vibration apparatus can generate a vibration according to the configuration parameter. A vibration should not be narrowly understood as the number of vibrations being one. For example, the vibration apparatus vibrating at the vibration frequency within the vibration duration can be considered a vibration, but the number of vibrations at the vibration frequency within the vibration duration can be one or more times.

At S103, based on the first data and the second data, target data is generated. The target data is used to output vibration in response to the configuration parameter of the control instruction during the process of outputting the plurality of frames of captured images.

In some embodiments, in response to the target instruction, both the process of continuously obtaining the plurality of frames of captured images and the process of obtaining the configuration parameter for the control instruction can be ongoing. When the process of continuously obtaining the plurality of frames of captured images and the plurality of frames of captured images forming the first data ends, the process of generating the target data can end accordingly based on the first data and the second data.

For example, in response to the target instruction, based on N frames of captured images that have been continuously obtained, when a (N+1)-th frame of captured image is continuously obtained, the control instruction can be generated. For the control instruction, the configuration parameter for the control instruction can be obtained. The configuration parameter can form the second data. When the captured image is no longer to be obtained continuously after a (N+3)-th frame of the captured image is continuously obtained, the (N+3)-th frame of captured image can form the first data. Based on the first data and the second data, the target data can be generated. The process of generating the target data can end when the process of continuously obtaining the N+3 frames of captured images ends. The target data can be used to output the vibration in response to the configuration parameter of the control instruction corresponding to the N+1 frames of captured images during the process of outputting the N+3 frames of captured images.

In some embodiments, in response to the target instruction, the plurality of frames of captured images can be continuously obtained. The plurality of frames of captured images can form the first data. In response to the target instruction, the configuration parameter for at least one control instruction can be obtained. The configuration parameter can form the second data. The configuration parameter for the at least one control instruction can be obtained when the process of continuously obtaining the plurality of frames of captured images continues, and the process of the configuration parameter forming the second data can be ongoing too. When the process of continuously obtaining the plurality of frames of captured images ends, the process of generating the target data based on the first data and the second data can end accordingly. The generated target data can be used to output the vibration in response to the configuration parameter of the control instruction during the process of outputting the plurality of frames of captured images. Thus, the recording function can be enhanced.

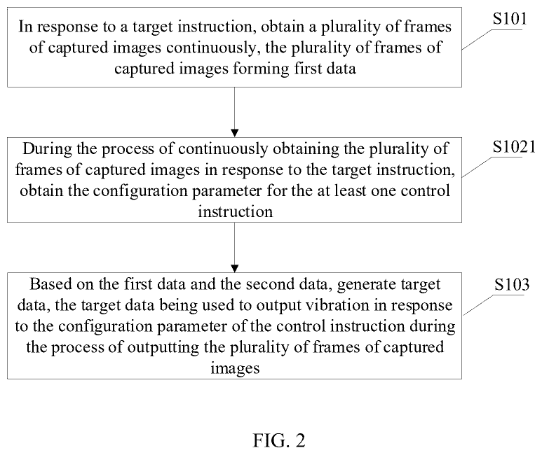

In some other embodiments of the present disclosure, FIG. 2 is a schematic flowchart of another data processing method according to some embodiments of the present disclosure. As shown in FIG. 2, the method is for process S102 in FIG. 1. Process S102 includes but is not limited to the following processes.

At S1021, during the process of continuously obtaining the plurality of frames of captured images in response to the target instruction, the configuration parameter for the at least one control instruction is obtained.

In some embodiments, during the process of continuously obtaining the plurality of frames of captured images, one or more control instructions can be generated. For each control instruction, a configuration parameter for the control instruction can be obtained.

During the process of continuously obtaining the plurality of frames of captured images, the configuration parameter for the control instruction can be obtained. The configuration parameter can form the second data. When the process of continuously obtaining the plurality of frames of captured images and the plurality of frames of captured images forming the first data ends, the configuration parameter for the control instruction can be obtained. The process of the configuration parameter forming the second data and the process of generating the target data based on the first data and the second data can end accordingly.

In some embodiments, by responding to the target instruction, the plurality of frames of captured images can be continuously obtained. The plurality of frames of captured images can form the first data. During the process of continuously obtaining the plurality of frames of captured images in response to the target instruction, the configuration parameter for the at least control instruction can be obtained. The configuration parameter can form the second data. When the process of continuously obtaining the plurality of frames of captured images, the process of obtaining the configuration parameter for the at least one control instruction during the process of outputting the plurality of frames of captured images. Thus, the recording function can be enhanced.

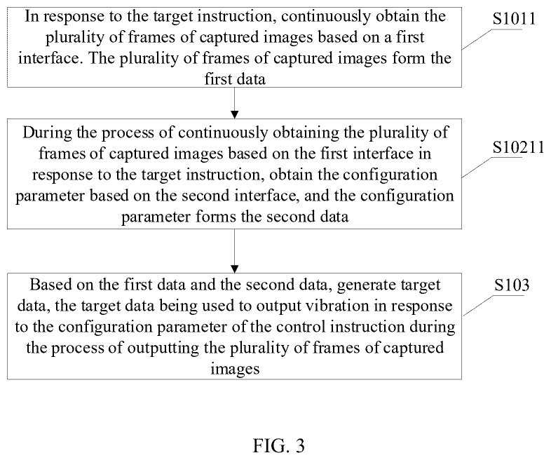

In some other embodiments, FIG. 3 is a schematic flowchart of another data processing method according to some embodiments of the present disclosure. As shown in FIG. 3, the method is for process S101 and process S1021 in FIG. 1 and FIG. 2. Process S101 includes but is not limited to the following processes.

At S1011, in response to the target instruction, the plurality of frames of captured images are continuously obtained based on a first interface. The plurality of frames of captured images form the first data.

In some embodiments, the plurality of frames of captured images can come from the electronic device. For example, based on the first interface, a plurality of frames of screen-captured images can be continuously obtained. The plurality of frames of screen-captured images can reflect the operations on the screen of the electronic device and the content displayed on the screen.

At S10211, during the process of continuously obtaining the plurality of frames of captured images based on the first interface in response to the target instruction, the configuration parameter is obtained based on the second interface, and the configuration parameter forms the second data.

During the process of continuously obtaining the plurality of frames of captured images based on the first interface, the electronic device can generate one or more vibrations. If more vibrations are generated, differences may exist between different vibrations.

Generating vibrations can include an application in the electronic device generating a control instruction and specifying the configuration parameters corresponding to the vibration, the application calling a second interface and sending the control instruction and the configuration parameter to the processor of the electronic device through the second interface, and the processor controlling the vibration apparatus to vibrate according to the configuration parameter according to the control instruction.

One vibration can correspond to one control instruction, and one control instruction can correspond to one configuration parameter. The configuration parameters corresponding to different vibrations can be different.

In a scenario of the electronic device generating the vibration during the process of continuously obtaining the plurality of frames of captured images based on the first interface, the configuration parameter can be obtained based on the second interface. Each time the configuration parameter is obtained, a control instruction can be corresponded.

The first interface can be different from the second interface.

The processor for receiving the control instruction and the configuration parameter can include but is not limited to a CPU or a control chip of the vibration apparatus.

In some embodiments, by responding to the target instruction, the plurality of frames of captured images can be continuously obtained. The plurality of frames of captured images can form the first data. During the process of continuously obtaining the plurality of frames of captured images based on the first interface in response to the target instruction, the configuration parameter can be obtained based on the second interface, and the configuration parameter can form the second data. Based on the first data and the second data, the target data can be generated. Thus, the plurality of frames of captured images from the electronic device and the vibration generated during the process of continuously obtaining the plurality of frames of captured images can be recorded together to enhance the recording function.

The application scenario of the electronic device can be better restored based on the target data.

For example, if a user wants to record a process of an incoming call vibration for interaction design, the user can input a target instruction to the electronic device before or during the incoming call. The electronic device can respond to the target instruction, continuously obtain the plurality of frames of captured images based on the first interface. The plurality of frames of captured images can reflect the incoming call interface displayed on the screen, and the plurality of frames of captured images can form the first data. During the process of continuously obtaining the plurality of frames of captured images based on the first interface in response to the target instruction, the configuration parameter can be obtained based on the second interface. The configuration parameter can form the second data. The configuration parameter can correspond to the control instruction. The control instruction can be used to call the at least one vibration apparatus. Based on the first data and the second data, the target data can be generated, and the incoming call interface and the incoming call vibration can be restored according to the target data.

Of course, this example shows the minimum scope of the incoming call scenario. When the incoming call process is recorded, in addition to recording the incoming call interface and the incoming call vibration, the incoming call ringtone can also be recorded. Thus, the incoming call interface, the incoming call ringtone, and the incoming call vibration can be restored according to the target data. The solution of recording the incoming call interface, the incoming call ringtone, and the incoming call vibration are also within the scope of the present disclosure.

For another example, if a user wants to record a game clip to share with other users, the user can input a target instruction to the electronic device before opening the game application or during the game. The electronic device can respond to the target instruction to continuously obtain the plurality of frames of the captured images based on the first interface. The plurality of frames of captured images can reflect the scenes during the game displayed on the screen, and the plurality of frames of captured images can form the first data. During the process of continuously obtaining the plurality of frames of captured images based on the first interface in response to the target instruction, the configuration parameter can be obtained based on the second interface. The configuration parameter can form the second data. The configuration parameter can correspond to the control instruction. The control instruction can be used to call the at least one vibration apparatus. Based on the first data and the second data, the target data can be generated. The scenes and the vibrations during the game can be restored according to the target data, e.g., the vibration when shooting or the vibration when exploding. Thus, the other users can experience the game immersively according to the restoration according to the target data.

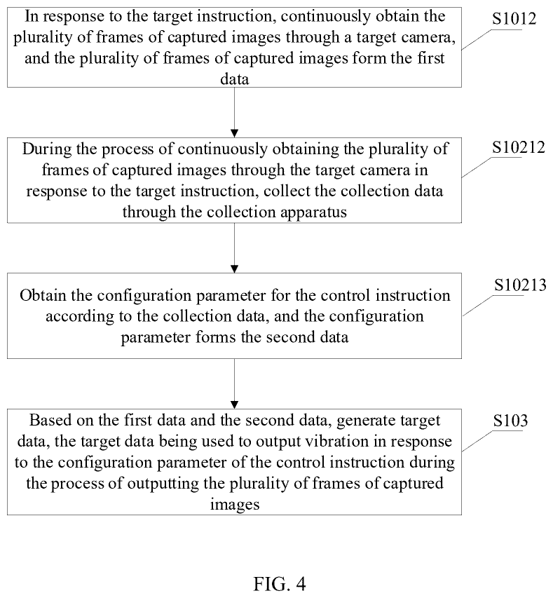

In some other embodiments, FIG. 4 is a schematic flowchart of another data processing method according to some embodiments of the present disclosure. As shown in FIG. 4, the method is for process S101 and process S1021 in FIG. 1 and FIG. 2. Process S101 includes but is not limited to the following processes.

At S1012, in response to the target instruction, the plurality of frames of captured images are continuously obtained through a target camera, and the plurality of frames of captured images form the first data.

In some embodiments, the target instruction can be used to cause the electronic device to call the target camera. For example, the electronic device can open the camera application, and generate the target instruction when a trigger operation input by the user indicating continuous acquisition of the plurality of frames of captured images is received.

The target camera can be a camera selected from the at least one camera of the electronic device. The implementation of selecting the target camera from the at least one camera of the electronic device may not be limited in the present disclosure.

Process S1021 can include but is not limited to the following processes.

At S10212, during the process of continuously obtaining the plurality of frames of captured images through the target camera in response to the target instruction, the collection data is collected through the collection apparatus.

In some embodiments, since the existing recording function through the camera is relatively single, an implementation is provided to enhance the recording function through the camera. That is, during the process of continuously obtaining the plurality of frames of captured images through the target camera, the recording function through the target camera can be enhanced by the collection apparatus.

The collection apparatus is a device different from the target camera. Accordingly, the collection data obtained by the collection apparatus is also different from the captured images obtained by the target camera.

At S10213, the configuration parameter for the control instruction is obtained according to the collection data, and the configuration parameter forms the second data.

In some embodiments, the configuration parameter for the control instruction can be used to make the electronic device subsequently generate control instruction and output the corresponding vibrations based on the control instruction.

The target data generated based on the first data and the second data can be used to generate the control instruction during the process of outputting the plurality of frames of captured images in response to the control instruction and output the vibration based on the control instruction and the configuration parameter.

In some embodiments, by responding to the target instruction, the plurality of frames of captured images can be continuously obtained through the target camera. The collection data can be obtained through the collection apparatus during the process of continuously obtaining the plurality of frames of captured images through the target camera in response to the target instruction. The configuration parameter for the control instruction can be obtained according to the collection data. The configuration parameter can form the second data. Based on the first data and the second data, the target data can be generated. Thus, the recording function through the target camera can be enhanced by the collection data obtained through the collection apparatus.

After the recording function through the target camera is enhanced, when outputting the plurality of frames of captured images obtained through the target camera subsequently, the control instruction can be generated during the process of outputting the plurality of frames of captured images based on the target data. The vibration apparatus can be controlled to vibrate according to the configuration parameter according to the control instruction to optimize the output effect of the plurality of frames of captured images. In some embodiments, in the playback progress during the process of outputting the plurality of frames of captured images based on the target data, the control instruction can be generated in response to the configuration parameter of the control instruction. The control instruction and the configuration parameter can be sent to the processor of the electronic device (e.g., the chip of the vibration apparatus). The processor of the electronic device can control the vibration apparatus to vibrate according to the configuration parameter and the control instruction.

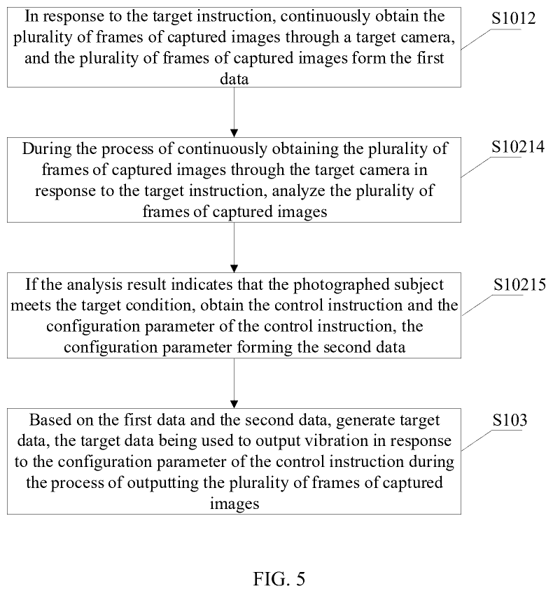

In some other embodiments, FIG. 5 is a schematic flowchart of another data processing method according to some embodiments of the present disclosure. The method is for process S101 and S1021 above. As shown in FIG. 5, process S101 includes but is not limited to the following processes.

At S1013, in response to the target instruction, the plurality of frames of captured images are continuously obtained through the target camera.

For the detailed processes of S1013, reference can be made to the relevant description of process S1012 above, which is not repeated here.

Process S1021 can include but is not limited to the following processes.

At S10214, during the process of continuously obtaining the plurality of frames of captured images through the target camera in response to the target instruction, the plurality of frames of captured images are analyzed.

In some embodiments, the plurality of frames of captured images can be analyzed

based on technologies such as image recognition, image detection, and image enhancement to obtain an analysis result. The analysis result can include the posture and movements of the photographed subject and the position of the photographed subject in the image.

At S10215, if the analysis result indicates that the photographed subject meets the target condition, the control instruction and the configuration parameter of the control instruction are obtained, and the configuration parameter forms the second data.

In some embodiments, the target condition can be set according to the type of the photographed subject, and the specific setting method is not limited. For example, if the photographed subject is a person, the photographed subject satisfying the target condition can include the person having a jumping action. In some other embodiments, if the photographed subject is the sky, the photographed subject satisfying the target condition can include fireworks exploding in the sky.

In some embodiments, if the analysis result indicates that the photographed subject meets the target condition, the preset control instruction corresponding to the photographed subject and the configuration parameter of the control instruction can be obtained.

In some embodiments, the control instruction and the configuration parameter of the control instruction can be obtained based on the analysis result. For example, based on the posture and movements of the person in the analysis result, the person can be determined to have a jumping action. Based on the parameters of the target camera, the known ground height, and the position of the person in the image in the analysis result, the jumping height of the person can be determined.

Based on the jumping scene (one or more jumping actions in the jumping scene), a control instruction can be obtained, and the jumping height can be converted into vibration intensity. The vibration intensity can be a configuration parameter of the control instruction.

Alternatively, in the jumping scene, a control instruction can be obtained for each jumping action. The jumping height can be converted into vibration intensity. By controlling the number of control instructions, the subsequent vibration frequency can be affected. The vibration intensity and the vibration frequency can be configuration parameters of the control instruction. The vibration intensity can be higher when the jumping height is higher.

The control instruction obtained in this process can be mainly used to form the second data. The control instruction obtained in this process can be applied to the electronic device outside the process of continuously obtaining the plurality of frames of captured images through the target camera to avoid affecting the shooting effect of the target camera due to the vibration generated by the electronic device during the process of continuously obtaining the plurality of frames of captured images through the target camera.

In some embodiments, since the current recording function through the camera is relatively single, the recording function through the target camera can be enhanced by analyzing the plurality of frames of captured images during the process of continuously obtaining the plurality of frames of captured images through the target camera.

After the recording function through the target camera is enhanced when the plurality of frames of captured images obtained through the target camera are output subsequently, based on the target data, the vibration apparatus can be controlled to vibrate according to the configuration parameter and the control instruction during the process of outputting the plurality of frames of captured images. Thus, the output effect of the plurality of frames of the captured images can be optimized.

In some other embodiments, another data processing method can be provided for obtaining the configuration parameter of the control instruction above. Obtaining the configuration parameter of the control instruction can include but is not limited to the following processes.

At S31, based on the sound collection data and analysis result, the configuration parameter of the control instruction is obtained.

In some embodiments, the sound collection data can assist the analysis result to obtain the configuration parameter of the control instruction. For example, if the photographed subject is a person, based on the posture and movements of the person in the analysis result, the person can be determined to have a jumping action. Based on the parameters of the target camera, the known ground height, and the position of the person in the image in the analysis result, the jumping height of the person can be determined, and the jumping height can be converted into the vibration intensity.

By analyzing the sound collection data, the time of each landing can be obtained. Based on the time of each landing, the vibration frequency can be determined. The vibration frequency can correspond to the frequency of landing.

The vibration intensity and vibration frequency can be the configuration parameters of the control instruction.

In some embodiments, the sound collection data can be obtained through the sound collection apparatus. The sound collection apparatus can correspond to the collection area of the target camera.

At S31, based on the ambient light collection data and analysis result, the configuration parameter of the control instruction is obtained.

In some embodiments, the ambient light collection data can assist the analysis result to obtain the configuration parameter of the control instruction. For example, if the photographed subject is the sky, based on the analysis result, a fireworks explosion can be determined in the sky. By analyzing the ambient light collection data, the brightness change of the sky can be obtained. Based on the duration of the brightness change, the vibration duration can be determined. The vibration duration can correspond to the time of the fireworks burning in the sky.

The vibration intensity and vibration frequency can be the configuration parameters of the control instruction.

In some embodiments, the sound collection data can be obtained through the sound collection apparatus. The sound collection apparatus can correspond to the collection area of the target camera.

In some embodiments, the ambient light collection data can be obtained through the ambient light sensing apparatus. The ambient light sensing apparatus can correspond to the collection area of the target camera.

In some embodiments, by responding to the target instruction, the plurality of frames of captured images can be continuously obtained through the target camera. The plurality of frames of captured images can form the first data. During the process of continuously obtaining the plurality of frames of captured images through the target camera in response to the target instruction, the analysis result can be assisted by at least one of the sound collection data or the ambient light collection data to obtain the configuration parameter of the control instruction. The configuration parameter can form the second data. Based on the first data and the second data, the target data can be generated. Thus, the recording function through the target camera can be enhanced by at least one of the sound collection data or the ambient light collection data and the plurality of frames of captured images.

Then, the present disclosure provides a data processing apparatus, which corresponds to the data processing method above. Thus the data processing apparatus and the data processing method can refer to each other.

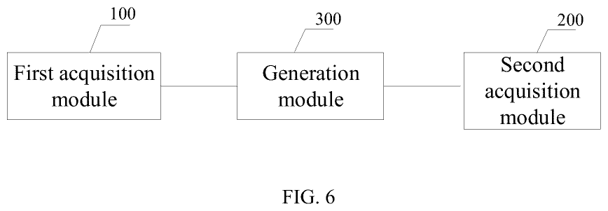

As shown in FIG. 6, the data processing apparatus includes a first acquisition module 100, a second acquisition module 200, and a generation module 300.

The first acquisition module 100 can be configured to respond to the target instruction to continuously obtain the plurality of frames of captured images. The plurality of frames of captured images can form the first data.

The second acquisition module 200 can be configured to respond to the target instruction to obtain the configuration parameter of at least one control instruction. The configuration parameter can form the second data. The control instruction can be used to call at least one vibration apparatus.

The generation module 300 can be configured to generate the target data based on the first data and the second data. The target data can be used to output the vibration in response to the configuration parameter of the control instruction during the process of outputting the plurality of frames of captured images.

The second acquisition module 200 can be configured to obtain the configuration parameter for at least one control instruction during the process of continuously obtaining the plurality of frames of captured images in response to the target instruction.

The process of the first acquisition module 100 continuously obtaining the plurality of frames of captured images can include continuously obtaining the plurality of frames of captured images based on the first interface.

The process of the second acquisition module 200 obtaining the configuration parameter for the at least one control instruction can include obtaining configuration parameters based on the second interface. Each time obtaining the configuration parameter can correspond to one control instruction. The first interface and the second interface can be different.

The first acquisition module 100 can be configured to continuously obtain the plurality of frames of captured images through the target camera in response to the target instruction.

The second acquisition module 200 obtaining the configuration parameter for the at least one control instruction during the process of continuously obtaining the plurality of frames of captured images in response to the target instruction can include obtaining the collection data through the collection apparatus during the process of continuously obtaining the plurality of frames of captured images through the target camera in response to the target instruction and obtaining the configuration parameter for the control instruction according to the collection data.

The second acquisition module 200 obtaining the configuration parameter for the control instruction according to the collection data can include one of if the collection data satisfying the target condition, converting the collection data into the configuration parameter of the control instruction, or if the change amount of the collection data satisfies the target condition, converting the collection data into the configuration parameter of the control instruction.

The second acquisition module 200 obtaining the collection data through the collection apparatus can include one of obtaining the sound collection data through the sound collection apparatus, the sound collection apparatus corresponding to the collection area of the target camera, or obtaining the ambient light collection data through the ambient light sensing apparatus, the ambient light sensing apparatus corresponding to the collection area of the target camera.

The first acquisition module 100 can be configured to continuously obtain the plurality of frames of captured images through the target camera in response to the target instruction.

The second acquisition module 200 obtaining the configuration parameter for the at least one control instruction during the process of continuously obtaining the plurality of frames of captured images during the process of continuously obtaining the plurality of frames of captured images through the target camera in response to the target instruction, and if the analysis result indicates that the photographed subject satisfies the target condition, obtaining the control instruction and the configuration parameter of the control instruction.

The second acquisition module 200 obtaining the configuration parameter of the control instruction can include one of obtaining the configuration parameter of the control instruction based on the sound collection data and the analysis result or obtaining the configuration parameter of the control instruction based on the ambient light collection data and the analysis result. The sound collection data can be obtained through the sound collection apparatus. The sound collection apparatus can correspond to the collection area of the target camera. The ambient light collection data can be obtained through the ambient light sensing apparatus. The ambient light sensing apparatus can correspond to the collection area of the target camera.

Corresponding to the data processing method of the present disclosure, the present disclosure also provides an electronic device.

The electronic device can include a collection assembly and a processor.

The collection assembly can be configured to collect images. The collection assembly can include but is not limited to one of a camera of the electronic device or a collection assembly of the electronic device configured to record the screen content.

The processor can be configured to continuously obtain the plurality of frames of captured images in response to the target instruction. The plurality of frames of captured images can form the first data. The processor can be further configured to obtain the configuration parameter for at least one control instruction in response to the target instruction. The configuration parameter can form the second data. The control instruction can be used to call at least one vibration apparatus. The processor can be further configured to generate the target data based on the first data and the second data. The target data can be used to output the vibration in response to the configuration parameter of the control instruction during the process of outputting the plurality of frames of captured images.

Each embodiment focuses on differences from other embodiments. The same or similar parts of embodiments can refer to each other. Since apparatus embodiments are similar to method embodiments, the description of the apparatus embodiments are relatively simple. For the related parts, reference can be made to the description of the method embodiments.

In the present specification, the terms such as first and second are only used to distinguish one entity or operation from another entity or operation, and do not necessarily require or imply that any such actual relationship or order exists between these entities or operations. Moreover, the terms “include,” “comprise,” or any other variants thereof are intended to cover non-exclusive inclusion, so that a process, method, article, or device that includes a series of elements not only includes those elements, but also includes other elements that are not explicitly listed, or also includes elements inherent to such process, method, article, or device. When there are no more restrictions, the element defined by the statement “including a . . . ” do not exclude the existence of additional identical elements in the process, method, article, or device that includes the element.

To facilitate the description, the above apparatus can be described by dividing the functions into various modules. Of course, when the present disclosure is implemented, the functions of the modules can be implemented in the same one or more pieces of software and/or hardware.

From the description of the above implementations, those skilled in the art can understand that the present disclosure can be implemented by means of software plus a necessary general hardware platform. Based on this understanding, the essence or the part that contributes to the existing technology of the technical solution of the present disclosure can be embodied in the form of a software product. The computer software product can be stored in a storage medium, such as ROM/RAM, magnetic disks, optical disks, etc., and include several instructions to make a computer device (e.g., a personal computer, a server, or a network device, etc.) execute the methods of the embodiments of the present disclosure.

The data processing method, apparatus, and electronic device of the present disclosure are described in detail. Specific examples are used to describe the principles and embodiments of the present disclosure. The description of embodiments of the present disclosure is used to facilitate the understanding of the method and core ideas of the present disclosure. Meanwhile, those ordinary skills in the art can make modifications to embodiments and application scopes according to the concept of the present disclosure. These modifications are within the scope of the present disclosure. Thus, the description of the present specification cannot be understood as a limitation to the present disclosure.

What is claimed is:

1. A data processing method comprising:
in response to a target instruction, continuously obtaining a plurality of frames of captured images, the plurality of frames of captured images forming first data;
in response to the target instruction, obtaining a configuration parameter for at least one control instruction, the configuration parameter forming second data, and the at least one control instruction being used to call at least one vibration apparatus;
based on the first data and the second data, generating target data, the target data being used to output a vibration in response to the configuration parameter of the control instruction during a process of outputting the plurality of frames of captured images.

2. The data processing method according to claim 1, wherein obtaining the configuration parameter for the at least one control instruction in response to the target instruction includes:
during the process of continuously obtaining the plurality of frames of captured images in response to the target instruction, obtaining the configuration parameter for the at least one control instruction.

3. The data processing method according to claim 2, wherein continuously obtaining the plurality of frames of captured images includes:
continuously obtaining the plurality of frames of captured images based on a first interface;
obtaining the configuration parameter for the at least one control instruction including:
obtaining the configuration parameter based on a second interface, wherein each acquisition of the configuration parameter corresponds to one control instruction, and the first interface is different from the second interface.

4. The data processing method according to claim 2, wherein continuously obtaining the plurality of frames of captured images in response to the target instruction includes:
in response to the target instruction, continuously obtaining the plurality of frames of captured images through a target camera; and
obtaining the configuration parameter for the at least one control instruction during the process of continuously obtaining the plurality of frames of captured images in response to the target instruction including:
during the process of continuously obtaining the plurality of frames of captured images through the target camera in response to the target instruction, obtaining collection data through a collection apparatus; and
obtaining the configuration parameter for the control instruction based on the collection data.

5. The data processing method according to claim 4, wherein obtaining the configuration parameter for the control instruction based on the collection data includes one of:
in response to the collection data satisfying a target condition, converting the collection data into the configuration parameter for the control instruction; or
in response to a change amount of the collection data satisfying a target condition, converting the collection data into the configuration parameter for the control instruction.

6. The data processing method according to claim 5, wherein obtaining the collection data through the collection apparatus includes one of:
obtaining sound collection data through a sound collection apparatus, the sound collection apparatus corresponding to a collection area of the target camera; or
obtaining ambient light collection data through an ambient light sensing apparatus, the ambient light sensing apparatus corresponding to the collection area of the target camera.

7. The data processing method according to claim 2, wherein continuously obtaining the plurality of frames of captured images in response to the target instruction includes:
in response to the target instruction, continuously obtaining the plurality of frames of captured images through a target camera; and
obtaining the configuration parameter for the at least one control instruction during the process of continuously obtaining the plurality of frames of captured images in response to the target instruction including:
during the process of continuously obtaining the plurality of frames of captured images through the target camera in response to the target instruction, analyzing the plurality of frames of captured images; and
in response to an analysis result indicates that a photographed subject satisfying a target condition, obtaining the control instruction and the configuration parameter of the control instruction.

8. The data processing method according to claim 7, wherein obtaining the configuration parameter of the control instruction includes one of:
based on sound collection data and the analysis result, obtaining the configuration parameter of the control instruction, the sound collection data being obtained through a sound collection apparatus, and the sound collection apparatus corresponding to a collection area of the target camera; or
based on ambient light collection data and the analysis result, obtaining the configuration parameter of the control instruction, the ambient light collection data being obtained through an ambient light sensing apparatus, and the ambient light sensing apparatus corresponding to the collection area of the target camera.

9. A data processing apparatus comprising:
a first acquisition module configured to continuously obtain a plurality of frames of captured images in response to a target instruction, the plurality of frames of captured images forming first data;
a second acquisition module configured to obtain a configuration parameter for at least one control instruction in response to the target instruction, the configuration parameter forming second data, and the control instruction being used to call at least one vibration apparatus; and
a generation module configured to generate target data based on the first data and the second data; the target data being used to output a vibration in response to the configuration parameter of the control instruction during a process of outputting the plurality of frames of captured images.

10. The data processing apparatus according to claim 9, wherein the second acquisition module is further configured to:
during the process of continuously obtaining the plurality of frames of captured images in response to the target instruction, obtain the configuration parameter for the at least one control instruction.

11. The data processing apparatus according to claim 10, wherein:
the first acquisition module is further configured to continuously obtain the plurality of frames of captured images based on a first interface; and
the second acquisition module is further configured to obtain the configuration parameter based on a second interface, wherein each acquisition of the configuration parameter corresponds to one control instruction, and the first interface is different from the second interface.

12. The data processing apparatus according to claim 10, wherein:
the first acquisition module is further configured to, in response to the target instruction, continuously obtain the plurality of frames of captured images through a target camera; and
the second acquisition method is further configured to:
during the process of continuously obtaining the plurality of frames of captured images through the target camera in response to the target instruction, obtain collection data through a collection apparatus; and
obtain the configuration parameter for the control instruction based on the collection data.

13. An electronic device, comprising:
a collection assembly configured to collect images; and
a processor configured to:
in response to a target instruction, continuously obtain a plurality of frames of captured images, the plurality of frames of captured images forming first data;
in response to the target instruction, obtain a configuration parameter for at least one control instruction, the configuration parameter forming second data, and the at least one control instruction being used to call at least one vibration apparatus; and
based on the first data and the second data, generate target data, the target data being used to output a vibration in response to the configuration parameter of the control instruction during a process of outputting the plurality of frames of captured images.

14. The electronic device according to claim 13, wherein the processor is further configured to:
during the process of continuously obtaining the plurality of frames of captured images in response to the target instruction, obtain the configuration parameter for the at least one control instruction.

15. The electronic device according to claim 14, wherein the processor is further configured to:
continuously obtain the plurality of frames of captured images based on a first interface;
obtaining the configuration parameter for the at least one control instruction including:
obtain the configuration parameter based on a second interface, wherein each acquisition of the configuration parameter corresponds to one control instruction, and the first interface is different from the second interface.

16. The electronic device according to claim 14, wherein the processor is further configured to:
in response to the target instruction, continuously obtain the plurality of frames of captured images through a target camera;
during the process of continuously obtaining the plurality of frames of captured images through the target camera in response to the target instruction, obtain collection data through a collection apparatus; and
obtain the configuration parameter for the control instruction based on the collection data.

17. The electronic device according to claim 16, wherein the processor is further configured to:
in response to the collection data satisfying a target condition, convert the collection data into the configuration parameter for the control instruction; or
in response to a change amount of the collection data satisfying a target condition, convert the collection data into the configuration parameter for the control instruction.

18. The electronic device according to claim 17, wherein the processor is further configured to:
obtain sound collection data through a sound collection apparatus, the sound collection apparatus corresponding to a collection area of the target camera; or
obtain ambient light collection data through an ambient light sensing apparatus, the ambient light sensing apparatus corresponding to the collection area of the target camera.

19. The electronic device according to claim 14, wherein the processor is further configured to:
in response to the target instruction, continuously obtain the plurality of frames of captured images through a target camera;
during the process of continuously obtaining the plurality of frames of captured images through the target camera in response to the target instruction, analyze the plurality of frames of captured images; and
in response to an analysis result indicating that a photographed subject satisfying a target condition, obtain the control instruction and the configuration parameter of the control instruction.

20. The electronic device according to claim 19, wherein the processor is further configured to:
based on sound collection data and the analysis result, obtain the configuration parameter of the control instruction, the sound collection data being obtained through a sound collection apparatus, and the sound collection apparatus corresponding to a collection area of the target camera; or
based on ambient light collection data and the analysis result, obtain the configuration parameter of the control instruction, the ambient light collection data being obtained through an ambient light sensing apparatus, and the ambient light sensing apparatus corresponding to the collection area of the target camera.
